(19) United States
(12) Patent Application Publication
(10) Pub. No.: US 2005/0021167 A1
(43) Pub. Date: Jan. 27, 2005

(54) Apparatus and method for driving actuators as a function of rotational speed

(76) Inventor: Wilhelm Burger, Furth (DE)

Correspondence Address: WHITE & CASE LLP;PATENT DEPARTMENT, 1155 AVENUE OF THE AMERICAS, NEW YORK, NY, 10036, US

(21) Appl. No.: 10/856,570

(22) Filed: May 27, 2004

(30) Foreign Application Priority Data
May 30, 2003 (DE) 103 24 663.0

(51) Int. Cl. G06F 19/00

(52) U.S. Cl. 700/141

(57) ABSTRACT

The aim is to extend the life of actuators of a production machine, or a machine tool, or an automated handling unit, in particular a knitting machine. Provision is made for this purpose for it to be possible to set the drive voltage for an actuator device (2) of a rotating device (1), which can be rotated at different rotational speeds, of the production machine, or the machine tool, or the automated handling unit as a function of the rotational speed of the rotating device (1). In the case of knitting machines, the piezoceramic actuators, for example, are then driven using a DC voltage which is dependent on the rotational speed of the needle cylinder. As a result, the DC voltage which is continuously applied to the actuators can on average be reduced and the number of breakdowns brought about by, for example, the formation of crystals in lubricating oils can be reduced.

The present invention relates to an apparatus for controlling or regulating a production machine, a machine tool or an automated handling unit having a rotating device, that can be rotated at different rotational speeds, an actuator device that is operatively connected to the rotating device, and a voltage supply device for supplying the actuator device with a drive voltage. The present invention also relates to a corresponding method for controlling or regulating a production machine or a machine tool or an automated handling unit. In particular, the present invention relates to knitting machines.

In the case of industrial knitting machines, such as flat-knitting and circular-knitting machines, the movement of the needles, for example, is usually triggered by piezoceramic bending transducers. In this case, the bending transducers are driven using a fixed supply voltage of 190 VDC, for example. This supply voltage is at such a level that the switching speed of the transducers meets the requirements for the knitting machine even at high rotational speeds.

However, practical experience has shown that a DC voltage in the region of 190 volts presents considerable problems in a knitting machine. For example, the DC voltage may cause the lubricating oil used to form crystals, resulting in undesired conductive transition effects. This often results in the piezoceramic transducers, the printed circuit boards used, and other electrical and mechanical components failing.

The object of the present invention is, therefore, to propose a method and an apparatus for controlling or regulating a production machine, or a machine tool or an automated handling unit, which make it possible to reduce breakdowns of the production machine, the machine tool or the automated handling unit.

This object is achieved according to the invention by an apparatus for controlling or regulating a production machine, a machine tool, or an automated handling unit having a rotating device which can be rotated at different rotational speeds, an actuator device which is operatively connected to the rotating device, and a voltage supply device for supplying the actuator device with a drive voltage, it being possible to set the drive voltage for the actuator device as a function of the rotational speed of the rotating device.

The invention also provides a method for controlling or regulating a production machine, a machine tool or an automated handling unit having a rotating device which can be rotated at different rotational speeds, and an actuator device that is operatively connected to the rotating device by driving the actuator device using a drive voltage, the drive voltage for the actuator device being set as a function of the rotational speed of the rotating device.

The invention is based on the knowledge that the number of breakdowns of knitting machines, for example, increases, and the life of the knitting machines or their actuators is reduced, in proportion to the voltage applied and with respect to time. A basic starting point is to reduce the operating voltage of the piezoceramic transducers by a few volts, it always being necessary to maintain the required switching speed. However, the minimum switching time or maximum switching speed of the bending transducers is only required when a knitting machine is operating at its maximum rotational speed. This means that the switching speed of the transducers must increase in proportion to, or as a function of, the rotational speed. As a result of this a maximum supply voltage need also only be applied to the bending transducers at a maximum rotational speed. It has been established in tests that at low rotational speeds, i.e. with a slow switching time, an actuating force for the actuators that is produced by a low voltage is reliably sufficient for driving the needles.

Since, in continuous operation, a knitting machine operates at only approximately 60% of the maximum rotational speed, and, in addition, there are downtimes when the system is switched on, a reduction in the breakdown rate or an improvement of the quality and an increase in the life of the knitting machine can be expected when the supply voltage to the bending transducers is dependent on the rotational speed.

The production machine described in general above is preferably a textile production machine, and in particular a knitting machine, as has already been described. Furthermore, as has likewise already been mentioned, the actuator device preferably comprises at least one electromechanical transducer and, in particular, one or more piezoelectric elements.

The apparatus may also have a sensor device for sampling the rotational speed and/or position of the rotating device, the sensor device being connected to the voltage supply device. The actual rotational speed or the present absolute or relative position of the rotating device can thus be established and used for setting the drive voltage. As an alternative to this, the drive voltage or the drive current for the rotating device is used indirectly as the control variable for the drive voltage of the actuator device.

The voltage supply device preferably has a control device for a large number of actuators having a data line to the actuator device and a controllable voltage-transforming unit having a power supply line for supplying power to the large number of actuators at the same time. The drive voltage for the actuator device may be a DC voltage. For this purpose, the voltage supply device has, for example, an AC voltage/DC voltage converter. At a rotational speed of zero, the drive voltage should have a minimum value other than zero or a minimum amplitude other than zero. This makes it possible for a minimum bending state or minimum loading of the piezoceramic element to be maintained even over longer downtimes. If the piezoceramic transducers are not completely relieved of load, their total movement extent is reduced, which increases their life.

A textile production machine, in particular a knitting machine, is preferably equipped with the abovementioned apparatus.

The present invention will now be explained in more detail by way of example with reference to the attached drawings, in which:

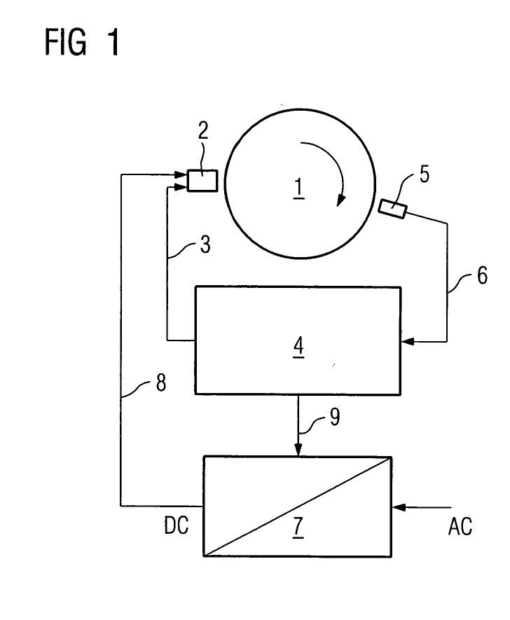

FIG. 1 shows an outline circuit diagram of a knitting machine according to the invention; and

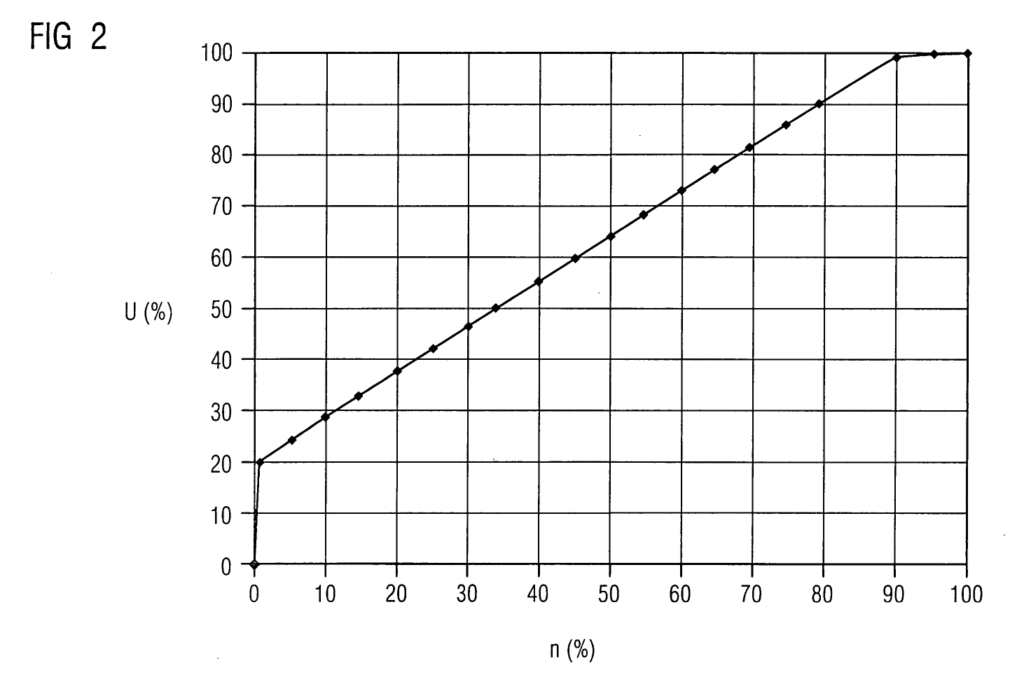

FIG. 2 shows a voltage characteristic according to the invention used for the actuators.

The embodiment explained in more detail below is a preferred exemplary embodiment of the present invention. A knitting machine is symbolized in FIG. 1 by its needle cylinder 1. This rotates as shown by the arrow drawn. During the knitting procedure, the needles are moved in the needle cylinder correspondingly to form a mesh. In the process, the needles may be moved individually or in groups at the same time or one after the other. The movement of the needles is triggered by piezoceramic actuators. Only one of these actuators 2 is shown in FIG. 1. These actuators 2 are distributed over the circumference of the rotating device or the needle cylinder 1.

Each actuator 2 is logically controlled by a control device 4 via a data line 3. For this purpose, the rotational speed of the needle cylinder 1 or its relative or absolute position is transmitted as a needle pulse signal in a sensor line 6 to the control system 4 by means of an incremental angle encoder 5.

A voltage supply unit 7, in this case an AC/DC converter, supplies each of the actuators 2 with a DC voltage via a power supply line 8. Via a control line 9, the controllable voltage supply unit 7 receives a needle clock from the control device 4. This makes it possible for the level of the supply voltage for the actuators to be set as a function of the rotational speed.

The relationship between the voltage at the actuators 2 and the rotational speed is illustrated by way of example in FIG. 2 as a characteristic. In a rotational-speed range of approximately 0% to 90% of the maximum rotational speed, the voltage increases approximately linearly with the rotational speed. It reaches a maximum voltage of U=100% at a maximum rotational speed of n=100%. When the rotating device or the needle cylinder 1 is at rest (n=0%), the actuators may be supplied with a minimum voltage in order to maintain the load. In this case, the voltage is not reduced to U=0% when at rest as is illustrated by the characteristic in FIG. 2, but remains at, for example, U=20% of the maximum voltage. As a result, the dynamic range of the piezoelectric elements is reduced and their life is increased.

The characteristic illustrated in FIG. 2 may be stored in the control device 4. The control device 4 in this case supplies a corresponding rotational-speed control signal to the AC/DC converter 7 in order to regulate it. As an alternative, the characteristic illustrated in FIG. 2 may also be stored directly in the voltage supply unit 7. In this case, the sensor signal may be passed on directly to the voltage supply unit 7 from the sensor 5. It is also possible for the sensor signal to be passed on to the voltage supply unit 7 via only the control device 4 without being specially conditioned.

In any case, driving the actuators as a function of rotational speed increases the life of the generally relatively expensive actuators.

1-19. (canceled)

20. (new) an apparatus for controlling and regulating an automated machine, the apparatus comprising:
(a) a rotating device adapted to be rotated at different rotational speeds;
(b) an actuator device operatively connected to the rotating device; and
(c) a voltage supply device for supplying the actuator device with a drive voltage, the drive voltage set as a function of a sensed rotational speed of the rotating device.

21. The apparatus according to claim 20, wherein the automated machine comprises a textile production machine.

22. The apparatus according to claim 21, wherein the textile production machine comprises a knitting machine.

23. The apparatus according to claim 20, wherein the actuator device comprises at least one electromechanical transducer.

24. The apparatus according to claim 23, wherein the at least one electromechanical transducer comprises a piezoelectric element.

25. The apparatus according to claim 20, further comprising a sensor device connected to the voltage supply device, wherein the sensor device samples at least one of the group consisting of the rotational speed of the rotating device and the position of the rotating device.

26. The apparatus according to claim 20, wherein the voltage supply device comprises:
(a) a control unit for controlling a plurality of actuator devices, the control unit comprising a data line for connection to each of the plurality of actuator devices; and
(b) a controllable voltage-transforming unit comprising a power supply line for simultaneously providing electrical power to the plurality of actuator devices.

27. The apparatus according to claim 20, wherein the drive voltage comprises a DC voltage.

28. The apparatus according to claim 20, wherein the drive voltage of the rotational device comprises a non-zero amplitude value at a rotational speed of approximately zero.

29. The apparatus according to claim 20, wherein the automated machine comprises at least one of the group consisting of a production machine, a machine tool, and an automated handling unit.

30. A method for controlling an automated machine comprising at least one rotating device and at least one actuator device, the at least one rotating device adapted to be rotated at different rotational speeds and operatively connected to the at least one actuator device, the method comprising the steps of:
(a) applying a drive voltage to the at least one actuator device; and
(b) controlling the drive voltage to the at least one actuator device based on a determined rotational speed associated with the at least one rotating device.

31. The method according to claim 30, wherein the automated machine comprises a production machine.

32. The method according to claim 31, wherein the production machine comprises a textile production machine.

33. The method according to claim 31, wherein the production machine comprises a knitting machine having a plurality of needles and the actuators are associated with movement of the needles.

34. The method according to claim 30, wherein the at least one actuator device comprises at least one electromechanical transducer.

35. The method according to claim 34, wherein the at least one electromechanical transducer comprises a piezoelectric element.

36. The method according to claim 30, wherein the step of controlling the drive voltage comprises the steps of:
(a) sampling the rotational speed of the at least one rotating device; and
(b) controlling the drive voltage to the at least one actuator device based on the sampling of the rotation speed associated with the at least one rotating device.

37. The method according to claim 30, wherein the at least one actuator device is logically controlled by a data line.

38. The method according to claim 37, wherein the data line is coupled to a controller device.

39. The method according to claim 30, wherein the at least one actuator device is supplied with electrical power from a power supply line.

40. The method according to claim 30, wherein the drive voltage comprises a DC voltage.

41. The method according to claim 30, wherein at a rotational speed of approximately zero the drive voltage comprises a non-zero amplitude value.

42. A control system for reducing failures in an automation machine, the automation machine associated with at least one actuator device and at least one sensor device coupled to a rotating device, the control system comprising:
(a) controller means for receiving an input from the at least one sensor device and generating a control output based on measured characteristics associated with the at least one actuator and rotating device; and
(b) voltage supply means for generating a drive voltage based on the control output received from the controller device, the actuator device coupled to the voltage supply for receiving the drive voltage.

43. The system according to claim 42, wherein the at least one sensor comprises an incremental angle encoder for generating a sensor output signal that varies according to movement of the rotating device, and wherein the sensor output signal is compared with the measured characteristics for determining the control output.

44. The system according to claim 43, wherein the characteristics comprise a range of rotational speed values having corresponding voltage values.

45. The system according to claim 42, wherein the characteristics are stored in the controller device.

46. The system according to claim 42, wherein the characteristics are stored in the voltage supply device.

47. The system according to claim 42, wherein the at least one actuator device comprises at least one piezoceramic actuator for providing needle movements in a knitting machine.

48. A method for reducing failures in an automation machine utilizing at least one actuator device and at least one sensor device coupled to a rotating device, the method comprising the steps of:
(a) receiving from the at least one sensor device a signal associated with the motion of the rotating device;
(b) generating a drive voltage for the actuator device by processing the received signal associated with the rotation of the rotating device, the processing based on a characteristic relationship between the drive voltage and a speed of rotation of the rotating device; and
(c) applying the drive voltage to the at least one actuator device for generating movement wherein, based on the characteristic relationship, the drive voltage to the at least one actuator device is reduced as the rotational speed of the rotating device decreases.

49. The method according to claim 48, wherein the step of generating a drive voltage comprises selecting a drive voltage based on the characteristic relationship that is effective to reduce a likelihood of failure in the at least one actuator device.

50. The method according to claim 48, wherein the characteristic relationship comprises a range of voltages that may be applied to the actuator, each of the range of voltages selected based on a corresponding rotational speed associated with the rotating device.

51. The method according to claim 48, wherein the drive voltage comprises a DC voltage.

52. The method according to claim 48, wherein the processing is performed by a controller device.

53. The method according to claim 48, wherein the drive voltage is generated by a controllable voltage supply unit.

54. The method according to claim 48, wherein the automation machine comprises a knitting machine.

55. The method according to claim 48, wherein the at least one actuator device comprises at least one piezoceramic actuator.
